(19) United States
(12) Patent Application Publication
(10) Pub. No.: US 2019/0126750 A1
(43) Pub. Date: May 2, 2019

(54) VEHICLE AND CONTROL METHOD THEREOF

(71) Applicants: Hyundai Motor Company, Seoul (KR); Kia Motors Corporation, Seoul (KR)

(72) Inventor: Sang Joon Kim, Seoul (KR)

(21) Appl. No.: 15/959,201

(22) Filed: Apr. 21, 2018

(30) Foreign Application Priority Data
Nov. 1, 2017 (KR) 10-2017-0144380

(51) Int. Cl. B60K 26/02; B60W 30/16; B60W 50/16

(52) U.S. Cl. CPC B60K 26/021; B60W 30/162; B60W 50/16; B60W 2750/302; B60W 2420/54; B60W 2520/105; B60W 2720/106; B60W 2420/40

(57) ABSTRACT

A vehicle is provided that includes a detector that detects driving information of the vehicle and a controller that adjusts an accelerating pedal of the vehicle. The controller calculates a target speed of the vehicle based on the detected driving information and a first driving force required for the vehicle to be driven at the target speed and then adjusts the magnitude of pedal effort of the accelerating pedal when detected driving force of the vehicle does not correspond to the first driving force.

### CROSS-REFERENCE TO RELATED APPLICATION

This application is based on and claims priority under 35 U.S.C. § 119 to Korean Patent Application No. 10-2017-0144380 filed on Nov. 1, 2017, in the Korean Intellectual Property Office, the disclosure of which is incorporated herein by reference in its entirety.

### BACKGROUND

### 1. Field of the Disclosure

The present disclosure relates to a vehicle and control method thereof, and more particularly, to a technology for adjusting accelerating pedal effort in response to determining that the driving force of the vehicle is produced excessively.

### 2. Discussion of Related Art

In general, development of auto technologies is changing and facilitating traveling over long distances with increased convenience. The vehicle is also equipped with a brake system to decelerate or stop the vehicle when required and an accelerator to accelerate the vehicle while the vehicle is being driven.

Particularly, the brake system may generate braking force by converting moving energy from the traveling vehicle to thermal energy using friction and radiating the heat into the air. In the brake system, when the driver engages a brake pedal, hydraulic pressure or air pressure produced from the booster triggers operation of a brake cylinder mounted on the caliper, and the brake cylinder moves the pad to tightly press a round disc from both sides, generating frictional braking force. The accelerator may include an accelerating pedal, and when the accelerating pedal is engaged, the engine is rotated faster which increases the speed of the vehicle. Specifically, the accelerating pedal is engaged with a carburetor and may increase the speed of the vehicle in a way that adjusts an amount of gasoline and air to be transmitted to the engine.

The force required to engage the accelerating pedal or the brake pedal is referred to as pedal effort, and recently, a technology has been developed to prevent the driver from continuously stepping on the pedal by adjusting the pedal effort to prevent the driver from making rapid acceleration. It is common to preset a target acceleration of the vehicle, and when some force is applied to a pedal greater than the preset target acceleration, the driver is prevented from continuing to step on or engage the pedal by weighing the pedal effort. This may prevent energy loss from unnecessary acceleration of the vehicle. However, in the traditional technology, indiscriminate decision has been made to control the pedal effort, so the pedal effort is not efficiently controlled.

### SUMMARY

The present disclosure provides a vehicle and control method thereof for effectively controlling target accelerating pedal effort based on driving information of the vehicle.

In accordance with one aspect of the present disclosure, a vehicle includes a detector configured to detect driving information of the vehicle, a controller configured to adjust an accelerating pedal of the vehicle. The controller may be further configured to calculate target speed of the vehicle based on the detected driving information and first driving force required for the vehicle to be driven at the target speed, and adjust the magnitude of pedal effort of the accelerating pedal when detected driving force of the vehicle does not correspond to the first driving force.

The controller may be configured to adjust the magnitude of pedal effort of the accelerating pedal to cause the detected driving force of the vehicle to correspond to the first driving force. The controller may further be configured to generate repulsive force on the accelerating pedal to adjust the magnitude of pedal effort of the accelerating pedal. The controller may be configured to generate repulsive force when the detected driving force of the vehicle is greater than the first driving force. Additionally, the controller may be configured to calculate second driving force having a greater value than the first driving force, wherein repulsive force generated in a range between the first driving force and the second driving force and repulsive force generated in a range that exceeds the second driving force are different in magnitude.

The controller may be configured to generate a constant magnitude of repulsive force in a range between the first driving force and the second driving force. The controller may further be configured to generate repulsive force proportional to a difference between detected driving force of the vehicle and the second driving force when the detected driving force of the vehicle is greater than the second driving force. The controller may be configured to generate no repulsive force when the detected driving force of the vehicle is less than the first driving force.

The vehicle may further include a communication device configured to receive driving information of the vehicle and traffic information from at least one of a navigation terminal and an external server. The controller may be configured to calculate target speed of the vehicle based on the information received by the communication device. In particular, the controller may then be configured to calculate target speed of the vehicle based on a distance to another vehicle or obstruction located in front of the vehicle and the relative speed received from the detector.

In accordance with another aspect of the present disclosure, a vehicle method include detecting driving information of the vehicle, calculating target speed of the vehicle based on the detected driving information and first driving force required for the vehicle to be driven at the target speed and adjusting the magnitude of pedal effort of an accelerating pedal when detected driving force of the vehicle does not correspond to the first driving force.

The adjusting of the magnitude of pedal effort of the accelerating pedal may include adjusting the magnitude of pedal effort of the accelerating pedal to cause the detected driving force of the vehicle to correspond to the first driving force. The adjusting of the magnitude of pedal effort of the accelerating pedal may include generating repulsive force on the accelerating pedal to adjust the magnitude of pedal effort of the accelerating pedal. The adjusting of the magnitude of pedal effort of the accelerating pedal may include generating repulsive force when the detected driving force of the vehicle is greater than the first driving force.

Additionally, the adjusting of the magnitude of pedal effort of the accelerating pedal may include calculating second driving force having a greater value than the first driving force, wherein repulsive force generated in a range between the first driving force and the second driving force and repulsive force generated in a range that exceeds the second driving force are different in magnitude. The adjusting of the magnitude of pedal effort of the accelerating pedal may also include generating a constant magnitude of repulsive force in a range between the first driving force and the second driving force. The adjusting of the magnitude of pedal effort of the accelerating pedal may include generating repulsive force proportional to a difference between detected driving force of the vehicle and the second driving force when the detected driving force of the vehicle is greater than the second driving force. Further, the adjusting of the magnitude of pedal effort of the accelerating pedal may include generating no repulsive force when the detected driving force of the vehicle is less than the first driving force.

The vehicle method may further include receiving driving information of the vehicle and traffic information from at least one of a navigation terminal and an external server. The calculating of the target speed may include calculating target speed of the vehicle based on the received driving information of the vehicle and the traffic information. The calculating of the target speed may include calculating target speed of the vehicle based on a distance to another vehicle or obstruction located in front of the vehicle and the relative speed.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 shows the exterior of a vehicle, according to an exemplary embodiment of the present disclosure;

FIG. 2 shows the interior of a vehicle, according to an exemplary embodiment of the present disclosure;

FIG. 3 is a block diagram of some components of a vehicle, according to an exemplary embodiment of the present disclosure;

FIG. 4 is a flowchart illustrating a control method of a vehicle, according to an exemplary embodiment of the present disclosure; and

FIG. 5 shows a detailed sequence of producing pedal effort for an accelerating pedal, according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Exemplary embodiments and features as described and illustrated in the present disclosure are only preferred examples, and various modifications thereof may also fall within the scope of the disclosure. It will be understood that, although the terms first, second, third, etc., may be used herein to describe various elements, components, regions, layers and/or sections, these elements, components, regions, layers and/or sections should not be limited by these terms.

Exemplary embodiments of the present disclosure will now be described in detail with reference to accompanying drawings to be readily practiced by an ordinary skill in the art. It should be noted that what is irrelative to the present disclosure is omitted from the drawings.

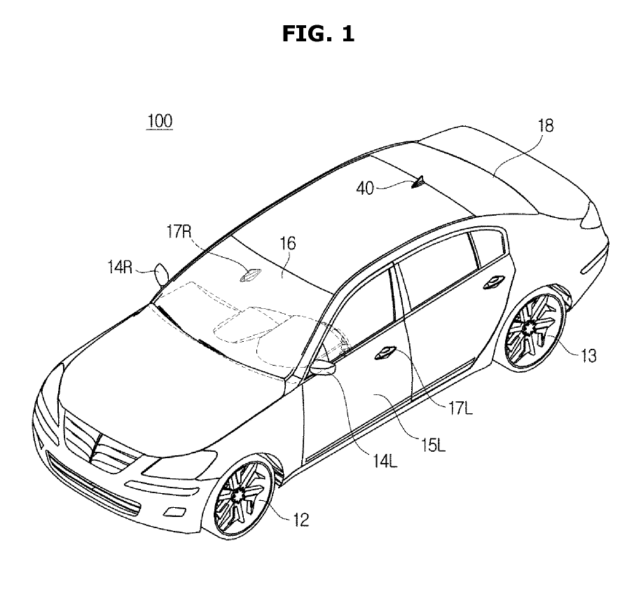

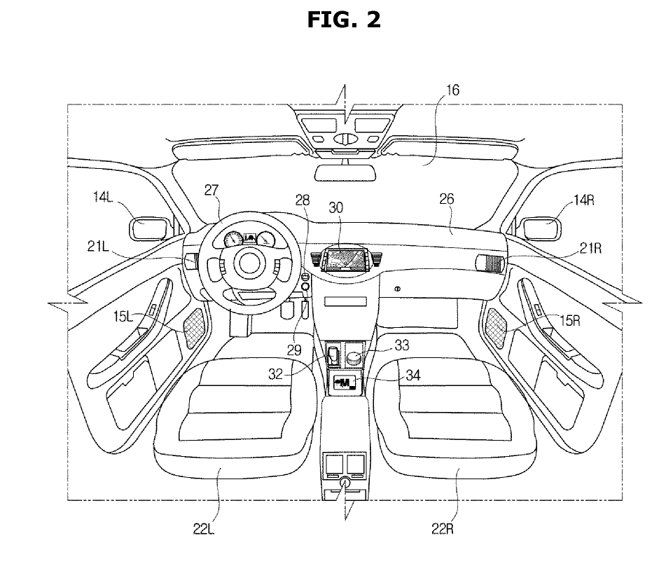

FIG. 1 shows the exterior of a vehicle 100, according to an exemplary embodiment of the present disclosure, and FIG. 2 is the interior of the vehicle 100, according to an exemplary embodiment of the present disclosure. The figures will now be described together to avoid overlapping explanation. Referring to FIG. 1, the exterior of the vehicle 100 may include wheels 12 and 13 for moving the vehicle 100, doors 15L for shielding the interior of the vehicle 100 from the outside, a front window 16 providing a view ahead of the vehicle 100, side mirrors 14L, 14R providing a view of areas behind and to the sides of the vehicle 100.

The wheels 12 and 13 may include front wheels 12 disposed in a front portion of the vehicle 100 and rear wheels 13 disposed in a rear portion of the vehicle 100, and a driving system (not shown) may be arranged inside the vehicle 100 for providing turning force to the front wheels 12 or rear wheels 13 to move the vehicle 10 forward or backward. The driving system may employ a motor that produces the turning force from electrical power supplied from a storage battery, or a combustion engine that burns a fuel to create the turning force.

The doors 15L and 15R are pivotally attached onto the left and right sides of the vehicle 100, and opened to provide access into the vehicle 100 and closed for shielding the interior of the vehicle 10 from the outside. Handles 17L and 17R may be mounted on the outer surface of the vehicle 100 to open or close the doors 15L and 15R. The front window 16 is mounted on the upper front of the main body to provide views ahead of the vehicle 100. The side mirrors 14L and 14R include the left side mirror 14L and the right side mirror 14R disposed on the left and right sides of the vehicle 100, respectively, for providing views behind and to the sides of the vehicle 100.

In addition, the vehicle 100 may include a sensor configured to detect an obstruction or other vehicles behind or to the sides of the vehicle 100 (e.g., the subject vehicle). The sensor may include a sensing device, such as an approximation sensor, a rainfall sensor configured to detect precipitation and whether it is raining, etc. The proximity sensor may be configured to transmit detection signals from the side or rear of the vehicle 100 and receive a reflection signal reflected from an obstruction or another vehicle. Based on the waveform of the received reflection signal, a controller of the vehicle 100 may be configured to determine whether there is another vehicle or obstruction behind and to the sides of the vehicle 100 and where the vehicle or obstruction is. For example, the proximity sensor may be configured to detect a distance to the obstruction by irradiating ultrasounds or infrared rays and receiving the reflected ultrasounds or infrared rays from the obstacles.

Referring to FIG. 2, in the center area of a dashboard 26, a display 30 may be provided for displaying video or images provided by an Audio Video Navigation (AVN) terminal. The display 30 may be configured to selectively display at least one of audio, video, and navigation screens, and in addition, display various control screens related to the vehicle 100 or screens related to additional functions. The display 30 may be implemented with Liquid Crystal Displays (LCDs), Light Emitting Diodes (LEDs), Plasma Display Panels (PDPs), Organic Light Emitting Diodes (OLEDs), Cathode Ray Tubes (CRTs), or the like, and may include a touch screen panel allowing the user to input a touch-based command.

Furthermore, a center input unit 33 of a jog shuttle type may be mounted between a driver seat 18L and a passenger seat 18R. The user may input a control command by turning or pressing (or otherwise engaging) the center input unit 33 or pushing the center input unit 62 to left, right, up or down (e.g., manipulating the unit). A speaker 23 configured to output sound may be mounted inside the vehicle 100. The speaker 23 may be configured to output sound required in performing audio, video, navigation, and other additional functions. The speaker 23 (23L, 23R) may be disposed in front of each of the driver's seat 22L and the passenger seat 22R in FIG. 2, without being limited thereto. For example, speakers may be disposed in various positions inside the vehicle.

A steering wheel 27 may be mounted on the dashboard 26 in front of the driver seat 22L, and a key hole 28 may be formed in an area near the steering wheel 27 for a remote-control device (not shown), e.g., a fob key, to be inserted thereto. A remote-control device may be inserted into the key hole 28 to turn on/off the ignition of the vehicle 100, or the remote-control device and the vehicle 100 may be connected once authentication between them is completed via a wireless communication network.

Furthermore, a start button 29 may be disposed on the dashboard 26 to start/stop the engine of the vehicle 100. When the remote-control device is inserted into the key hole 28 or authentication is successfully completed between an external terminal and the vehicle 100 via a wireless communication network, the engine of the vehicle 100 may be started by manipulation of the start button 29. The vehicle 100 may also include an air conditioner configured to perform heating or cooling and release the heated or cooled air through vents 21 to adjust the temperature inside the vehicle 100. The vents 21 (21L, 21R) are disposed in front of the driver's seat 22L and the passenger seat 22R in FIG. 2, without being limited thereto. For example, the vents 21 may be disposed in other various positions inside the vehicle.

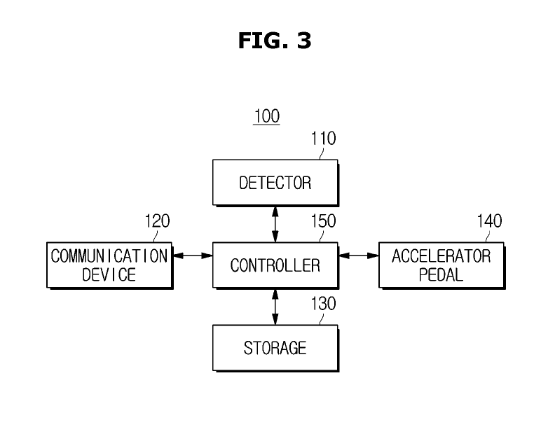

FIG. 3 is a block diagram of some components of the vehicle 100, according to an exemplary embodiment of the present disclosure. Referring to FIG. 3, the vehicle 100 may include a detector 110 (e.g., a sensor) configured to detect driving information of the vehicle 100, a communication device 120 configured to receive driving information of the vehicle and traffic information from an external server or a navigation terminal, a storage 130 configured to store information regarding the vehicle 100, and a controller 150 configured to calculate target speed and target driving force based on the received information from the detector 110 and the communication device 120 and operate the accelerating pedal 140 based on the calculation results.

In particular, the detector 110 may be configured to detect driving information of the vehicle 100 and transmit the detected information to the controller 150. Specifically, the detector 110 may be configured to detect a current speed, a change in speed, and wheel rotation speed of the vehicle 100. Furthermore, when the accelerating pedal 140 is engaged (e.g., pressure is exerted onto the pedal), the magnitude of the force applied to the accelerating pedal 140 and the magnitude of pedal effort produced by the accelerating pedal 140 may also be detected. The communication device 120 may be configured to receive driving information and traffic information of the vehicle 100 from the external server or a navigation terminal (not shown). Specifically, the traffic information may include information regarding a traffic condition of a road on which the vehicle 100 is traveling, e.g., information about a degree of congestion and speed limit, and even include information regarding the type and state of the road.

The communication device 120 may then be configured to communicate with the external server in various methods. For example, the communication device 120 may be configured to transmit and receive information to and from the server 200 based on various schemes, such as radio frequency (RF), wireless fidelity (Wi-Fi), Bluetooth, Zigbee, near field communication (NFC), ultra-wide band (UWB) communications, etc. The method for enabling communication with the server 200 is not limited thereto, but may be any type of method that may enable communication with the server 200. Although the communication device 120 is shown as a single component to transmit and receive signals in FIG. 3, it is not limited thereto, but may be implemented as separate transmitter (not shown) for transmitting signals and receiver (not shown) for receiving signals. Although the detector 110 and the communication device 120 are shown and described as separate components in FIG. 3, they are not limited thereto, and the detector 110 may also operate as the communication device 120 in some exemplary embodiments.

The storage 130 (e.g., memory) may be configured to store various types of information about the vehicle 100. Specifically, the storage 130 may be configured to store various types of information of the vehicle 100 required for the controller 150 to calculate target speed and target driving force of the vehicle 100, and transmit the information to the controller 150. The storage 130 may be implemented with at least one of a non-volatile memory device, such as cache, read only memory (ROM), programmable ROM (PROM), erasable programmable ROM (EPROM), electrically erasable programmable ROM (EEPROM), a volatile memory device, such as random access memory (RAM), or a storage medium, such as hard disk drive (HDD) or compact disk (CD) ROM, without being limited thereto. The storage 130 may be a memory implemented with a chip separate from a processor, which will be described later, in relation to the controller 150, or may be implemented integrally with the processor in a single chip.

Furthermore, although not shown, the display 30 may be configured to display various types of information regarding the vehicle. The controller 150 may be configured to adjust information displayed on the display 30, and specifically, operate the display 30 to display information regarding the current speed and driving force of the vehicle. The magnitude of pedal effort produced by the accelerating pedal 140 may also be displayed on the display 30, thereby providing the user with the information regarding the pedal effort. Accordingly, the display 30 may include a display panel (not shown) to represent the above-described information, and the display panel may employ a cathode ray tube (CRT), a display panel, a liquid crystal display (LCD), a light emitting diode (Led) panel, an organic LED panel, a plasma display panel (PDP), a field emission display (FED) panel, etc.

When the display 30 is implemented by a touch display, the display 30 may include a touch display panel (not shown) to receive a user input. The controller 150 may further be configured operate various devices mounted within the vehicle 100. Additionally, the controller 150 may be configured to execute operation and adjust pedal effort of the accelerating pedal 140 and calculate target speed of the vehicle 100 and target driving force required for the vehicle 100 to be driven at the target speed, based on the information of the vehicle 100 received from the detector 110 and the storage 130.

Specifically, the controller 150 may be configured to calculate the target speed at which the vehicle 100 may be driven in an optimal condition on the current road on which the vehicle 100 is traveling by considering the road traffic information and information regarding an obstruction in front of the subject vehicle received from the detector 110 or the communication device 120, and a distance from a preceding vehicle and the relative speed, and a property of the power train received from various sensors. The controller 150 may also be configured to calculate driving force currently required for the vehicle 100 to reach the target speed based on the calculated target speed and the information regarding the vehicle 100. Specifically, the controller 150 may be configured to calculate driving force required for the vehicle 100 to reach the target speed based on a kinetic equation of the vehicle, in real time.

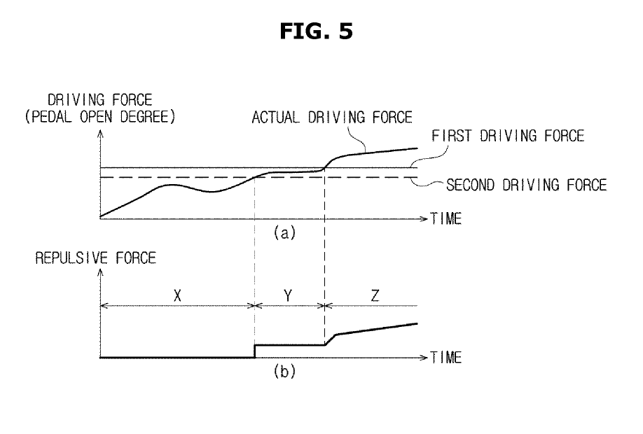

The target driving force may include first driving force and second driving force, and the second driving force may be greater than the first driving force. The first driving force refers to driving force having the same value as the calculated target driving force, and the second driving force refers to driving force having a value less than the first driving force. This will be described in detail with reference to FIG. 5.

When the detected driving force of the vehicle 100 does not correspond to the first driving force, the controller 150 may be configured to adjust the magnitude of pedal effort of the accelerating pedal to cause the driving force of the vehicle 100 to correspond to the first driving force. Specifically, the controller 150 may be configured to adjust a total magnitude of the pedal effort produced by the accelerating pedal 140 to generate a repulsive force on the accelerating pedal. This may effectively adjust the magnitude of the driving force produced from the vehicle 100, thereby preventing unnecessary energy loss.

Furthermore, the controller 150 may be configured to generate repulsive force on the accelerating pedal 140 when the detected driving force of the vehicle 100 is greater than the first driving force. When the detected driving force of the vehicle 100 is greater than the first driving force, unnecessary driving force is being produced, and thus, the repulsive force on the accelerating pedal 140 may be generated to reduce the driving force of the vehicle 100. On the contrary, when the detected driving force of the vehicle 100 is less than the first driving force, the vehicle 100 has not yet reached the target speed, and thus, the controller 150 may not generate the repulsive force.

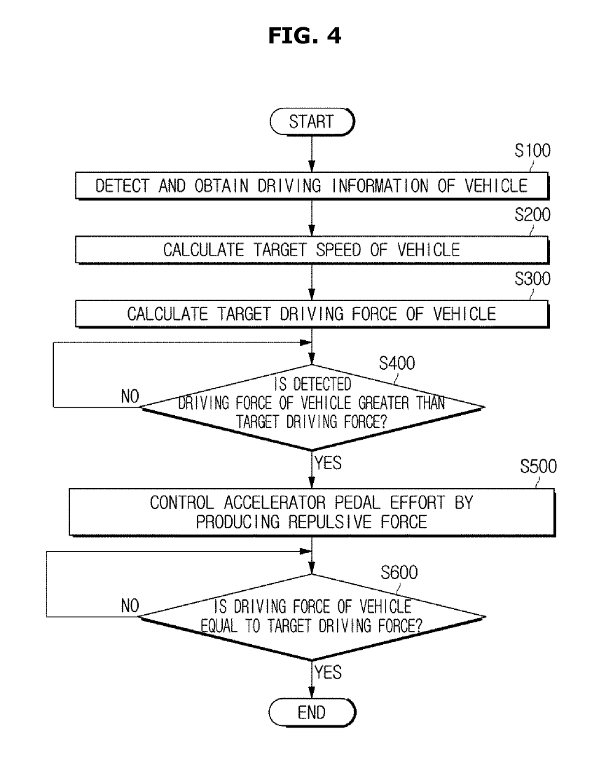

FIG. 4 is a flowchart illustrating a sequence of operation of the vehicle 100, according to an exemplary embodiment of the present disclosure, and FIG. 5 shows a detailed sequence of producing pedal effort for an accelerating pedal, according to an exemplary embodiment of the present disclosure. Referring to FIG. 4, the vehicle 100 may include a controller configured to detect and obtain driving information of the vehicle 100, in S100. The controller may be configured to execute the method described herein below.

Particularly, the vehicle 100 may be configured detect current speed, a change in speed, and wheel rotation speed of the vehicle 100. When the accelerating pedal 140 is engaged (e.g., pressure is being exerted onto the pedal), the magnitude of the force applied to the accelerating pedal 140 and the magnitude of pedal effort produced by the accelerating pedal 140 may also be detected. Once the driving information is obtained, the vehicle 100 may be configured to calculate target speed of the vehicle 100 based on the driving information, in S200.

The vehicle 100 may be configured to calculate the target speed at which the vehicle 100 may be driven in an optimal condition on a current road on which the vehicle 100 is traveling by considering the road traffic information and information regarding an obstruction in front of the vehicle 100, and a distance from a vehicle in front and the relative speed, and a property of the power train received from various sensors. The optimal condition may be, for example, a condition for running at a speed limit of the current road, a condition for maintaining the safety distance between the vehicle and the front and rear vehicles, a condition for allowing the vehicle to avoid a front obstacle safely, a condition for reaching the destination with the remaining fuel, a condition that are most appropriate to the specification of the power train, and the like.

Furthermore, the target speed may be set to various speed values based on the conditions of the vehicle 100. While the vehicle 100 is traveling a relatively short distance (e.g., less than a predetermined distance), the vehicle 100 may be configured to calculate target speed based on the driving condition of the vehicle 100, or while the vehicle 100 is traveling a substantially long distance (e.g., greater than the predetermined distance), the vehicle 100 may be configured to calculate target speed in consideration of the driving condition and also the driver's preference and fuel efficiency. For the short-distance driving, the target speed of the vehicle 100 may be calculated based on a distance to another vehicle or to an obstruction around the vehicle 100, information regarding the relative speed, whether there is a speed camera or a speed bump, whether there is an intersection or tollgate, etc.

However, for long-distance driving, the target speed of the vehicle 100 may be calculated based on a distance to another vehicle or to an obstruction around the vehicle 100, information regarding the relative speed, whether there is a speed camera or a speed bump, whether there is an intersection or tollgate, etc., and also on information regarding the driver's preference, fuel-efficient speed, fuel efficiency, information regarding SCC(Smart Cruise Control), etc. SCC is a system that automatically operates at the speed set by the driver, but measures the distance between vehicles through a radar sensor mounted on the front of the vehicle and maintains the proper inter-vehicle distance. Once the target speed is calculated, target driving force for the vehicle 100 to be driven at the target speed may be calculated, in S300.

In particular, the controller 100 may be configured to calculate target driving force required for the vehicle 100 to reach the target speed based on a kinetic equation. The target driving force may include first driving force and second driving force, where the second driving force may be greater than the first driving force. The first driving force may refer to driving force having the same value as the target driving force and the second driving force may refer to driving force having a value less than the first driving force. The vehicle 100 may be configured to determine whether the detected driving force of the vehicle 100 is greater than the target driving force, in S400.

When the detected driving force of the vehicle 100 is less than the first driving force, the vehicle 100 has not yet reached the target speed, and thus, no operation to control extra driving force may be performed. However, when the detected driving force of the vehicle 100 is greater than the first driving force, excessive driving force is being produced, and thus, the driving force requires adjustment. Accordingly, the vehicle 100 may be configured to adjust the driving force by adjusting the magnitude of the pedal effort of the accelerating pedal. Specifically, a total magnitude of the pedal effort produced by the accelerating pedal 140 may be adjusted to generate a repulsive force on the accelerating pedal, in S500.

Referring to FIG. 5, since driving force detected in area X is less than the target driving force, i.e., both the first driving force and the second driving force, it is not necessary to reduce the driving force. Accordingly, no repulsive force on the accelerating pedal 140 is generated in the area X. However, since the target driving force detected in areas Y and Z is greater than both the first driving force and the second driving force, the pedal effort of the accelerating pedal 140 may be adjusted by producing repulsive force in the areas Y and Z.

As shown in the figures, the second driving force is less than the first driving force, and the second driving force may be seen as a reference point from which to generate primary repulsive force. In other words, the driving force of the vehicle 100 detected in the area Y is less than the first driving force, it is not necessary to generate repulsive force. However, given that, when no repulsive force is generated, the driving force of the vehicle 100 may exceed the first driving force, repulsive force weaker than that in the area Z may be generated in the area Y. As shown in the figure, relatively weak repulsive force as compared to that in the area Z may be constantly generated.

When the driving force of the vehicle continues to increase and exceeds the first driving force (in the area Z) even when the repulsive force is generated in the area Y, it is necessary to reduce the driving force of the vehicle 100 and the magnitude of the repulsive force may be increased. As shown in the figure, repulsive force in proportion to a difference between the detected driving force of the vehicle 100 and the first driving force may be generated. Accordingly, proper repulsive force may be generated based on the magnitude of the driving force produced from the vehicle 100, which may effectively prevent unnecessary energy loss. Components of the vehicle 100 and control method of the vehicle 100 in accordance with an exemplary embodiment of the disclosure have thus far been described.

In the conventional technology, since a flat reference is used to adjust the pedal effort of the accelerating pedal, there is unnecessary loss of driving force. However, in accordance with an exemplary embodiment of the present disclosure, a vehicle may effectively adjust driving force of the vehicle in a way that calculates target driving speed and target driving force based on driving information of the vehicle and adjusts accelerating pedal effort when detected driving force of the vehicle does not correspond to the target driving force.

Although the present disclosure is described with reference to some exemplary embodiments as described above and accompanying drawings, it will be apparent to those ordinary skilled in the art that various modifications and changes may be made to the embodiments. For example, the aforementioned method may be performed in different order, and/or the aforementioned systems, structures, devices, circuits, etc., may be combined in different combinations from what is described above, and/or replaced or substituted by other components or equivalents thereof, to obtain appropriate results. Therefore, other exemplary embodiments and equivalents thereof may fall within the following claims.

In accordance with an exemplary embodiment of the present disclosure, a vehicle may effectively control the driving force thereof in a way that calculates target driving speed and target driving force based on driving information of the vehicle and adjust accelerating pedal effort when detected driving force of the vehicle does not correspond to the target driving force.

Several exemplary embodiments have been described above, but a person of ordinary skill in the art will understand and appreciate that various modifications can be made without departing the scope of the present disclosure. Thus, it will be apparent to those ordinary skilled in the art that the true scope of technical protection is only defined by the following claims.

What is claimed is:

1. A vehicle, comprising:
a detector configured to detect driving information of the vehicle; and
a controller configured to adjust an accelerating pedal of the vehicle,
wherein the controller is configured to calculate target speed of the vehicle based on the detected driving information and a first driving force required for the vehicle to be driven at the target speed, and adjust the magnitude of pedal effort of the accelerating pedal when a detected driving force of the vehicle does not correspond to the first driving force.

2. The vehicle of claim 1, wherein the controller is configured to adjust the magnitude of pedal effort of the accelerating pedal to cause the detected driving force of the vehicle to correspond to the first driving force.

3. The vehicle of claim 1, wherein the controller is configured to generate repulsive force on the accelerating pedal to adjust the magnitude of pedal effort of the accelerating pedal.

4. The vehicle of claim 3, wherein the controller is configured to generate repulsive force when the detected driving force of the vehicle is greater than the first driving force.

5. The vehicle of claim 3, wherein the controller is configured to calculate a second driving force having a greater value than the first driving force, wherein repulsive force generated in a range between the first driving force and the second driving force and repulsive force generated in a range that exceeds the second driving force are different in magnitude.

6. The vehicle of claim 5, wherein the controller is configured to generate a constant magnitude of repulsive force in a range between the first driving force and the second driving force.

7. The vehicle of claim 5, wherein the controller is configured to generate repulsive force proportional to a difference between detected driving force of the vehicle and the second driving force when the detected driving force of the vehicle is greater than the second driving force.

8. The vehicle of claim 1, wherein the controller is configured to generate no repulsive force when the detected driving force of the vehicle is less than the first driving force.

9. The vehicle of claim 1, further comprising:
a communication device configured to receive driving information of the vehicle and traffic information from at least one of a navigation terminal and an external server,
wherein the controller is configured to calculate target speed of the vehicle based on the information received by the communication device.

10. The vehicle of claim 1, wherein the controller is configured to calculate target speed of the vehicle based on a distance to another vehicle or obstruction located in front of the vehicle and the relative speed received from the detector.

11. A control method of a vehicle, comprising:
detecting, by a controller, driving information of the vehicle;
calculating, by the controller, target speed of the vehicle based on the detected driving information and a first driving force required for the vehicle to be driven at the target speed; and
adjusting, by the controller, a magnitude of pedal effort of an accelerating pedal when detected driving force of the vehicle does not correspond to the first driving force.

12. The method of claim 11, wherein the adjusting of the magnitude of pedal effort of the accelerating pedal includes:
adjusting, by the controller, the magnitude of pedal effort of the accelerating pedal to cause the detected driving force of the vehicle to correspond to the first driving force.

13. The method of claim 11, wherein the adjusting of the magnitude of pedal effort of the accelerating pedal includes:
generating, by the controller, repulsive force on the accelerating pedal to adjust the magnitude of pedal effort of the accelerating pedal.

14. The method of claim 13, wherein the adjusting of the magnitude of pedal effort of the accelerating pedal includes:
generating, by the controller, repulsive force when the detected driving force of the vehicle is greater than the first driving force.

15. The method of claim 13, wherein the adjusting of the magnitude of pedal effort of the accelerating pedal includes:
calculating, by the controller, a second driving force having a greater value than the first driving force, wherein repulsive force generated in a range between the first driving force and the second driving force and repulsive force generated in a range that exceeds the second driving force are different in magnitude.

16. The method of claim 15, wherein the adjusting of the magnitude of pedal effort of the accelerating pedal includes:
generating, by the controller, a constant magnitude of repulsive force in a range between the first driving force and the second driving force.

17. The method of claim 15, wherein the adjusting of the magnitude of pedal effort of the accelerating pedal includes:
generating, by the controller, repulsive force proportional to a difference between detected driving force of the vehicle and the second driving force when the detected driving force of the vehicle is greater than the second driving force.

18. The method of claim 11, wherein the adjusting of the magnitude of pedal effort of the accelerating pedal includes:
generating, by the controller, no repulsive force if the detected driving force of the vehicle is less than the first driving force.

19. The method of claim 11, further comprising:
receiving, by the controller, driving information of the vehicle and traffic information from at least one of a navigation terminal and an external server,
wherein the calculating of the target speed includes calculating, by the controller, target speed of the vehicle based on the received driving information of the vehicle and the traffic information.

20. The method of claim 11, wherein the calculating of the target speed includes:
calculating, by the controller, target speed of the vehicle based on a distance to another vehicle or obstruction located in front of the vehicle and the relative speed.
